(19) United States
(12) Patent Application Publication
(10) Pub. No.: US 2025/0044479 A1
(43) Pub. Date: Feb. 6, 2025

(54) METASURFACE, DESIGN METHOD, DESIGN DEVICE, ELECTRONIC DEVICE AND FABRICATION METHOD

(71) Applicant: SHENZHEN METALENX TECHNOLOGY CO.,LTD, Shenzhen (CN)

(72) Inventors: Yuxi Han, Shenzhen (CN); Chenglong HAO, Shenzhen (CN); Fengze TAN, Shenzhen (CN); Jian ZHU, Shenzhen (CN)

(73) Assignee: SHENZHEN METALENX TECHNOLOGY CO.,LTD, Shenzhen (CN)

(21) Appl. No.: 18/760,051

(22) Filed: Jul. 1, 2024

(30) Foreign Application Priority Data
Aug. 4, 2023 (CN) 202310980073.0
Aug. 4, 2023 (CN) 202322088992.5

(51) Int. Cl. G02B 1/00; G02B 1/115; G02B 27/00

(52) U.S. Cl. CPC G02B 1/002; G02B 1/115; G02B 27/0012; G02B 2207/101

(57) ABSTRACT

Provided is a metasurface, a design method, a design device, an electronic device and a fabrication method. An antireflection film is covered on the metasurface; the metasurface includes: a substrate; the substrate includes: a first side; and the first side of the substrate has a plurality of negative nanostructures at different locations, and the depth of the plurality of negative nanostructures is less than the thickness of the substrate; the antireflection film is covered on the surface of the first side of the substrate without the plurality of negative nanostructures.

### CROSS-REFERENCE TO RELATED APPLICATION

This application claims the benefit of priority from Chinese Patent Application No. 202310980073.0 filed on Aug. 4, 2023, and Chinese Patent Application No. 202322088992.5, filed on Aug. 4, 2023. The content of the aforementioned application, including any intervening amendments thereto, is incorporated herein by reference in its entirety.

### TECHNICAL FIELD

The present disclosure relates to the field of a metasurface, in particular to a metasurface, a design method, a design device, an electronic device, and a fabrication method.

### BACKGROUND

A metasurface is a two-dimensional film composed of artificial nanostructures in a specific arrangement. The transmittance of the metasurface is the key factor in determining whether the metasurface can be applied on a larger scale. Currently, the metasurfaces can be classified into a positive nanostructure metasurface and a negative nanostructure metasurface according to the type of nanostructures. Both types of metasurfaces have the technical disadvantage of low transmittance, which makes it difficult to meet the transmittance requirements of optical components in optical products. The prior art has disclosed many methods to improve the transmittance of positive nanostructure metasurface, but there is so far no solution to improve the transmittance of negative nanostructure metasurface. Therefore, how to improve the transmittance of the negative nanostructure metasurface needs to be solved urgently.

### SUMMARY

In view of the above technical problems, a metasurface, a design method, a design device, an electronic device and a fabrication method are provided according to embodiments of the present disclosure, so as to overcome the problems in the related art.

In the first aspect, A metasurface is provided, where an antireflection film is covered on the metasurface;

Where the metasurface comprises: a substrate; the substrate comprises: a first side; and the first side of the substrate has a plurality of negative nanostructures at different locations, and the depth of the plurality of negative nanostructures is less than the thickness of the substrate;
the antireflection film is covered on the surface of the first side of the substrate without the plurality of negative nanostructures.

Optionally, the equivalent optical path is greater than or equal to 0.55 um and less than or equal to 3.36 um as the light passes through the antireflection film.

Optionally, the equivalent optical path is greater than or equal to 0.55 um and less than or equal to 2.52 um as the light passes through the antireflection film when the working waveband of the metasurface is a far-infrared band.

Optionally, the equivalent optical path is greater than or equal to 0.8 um and less than or equal to 2.4 um as the light passes through the antireflection film.

Optionally, the equivalent optical path is greater than or equal to 0.99 um and less than

or equal to 3.66 um as the light passes through the antireflection film.

Optionally, the equivalent optical path is greater than or equal to 1.44 um and less than or equal to 3.2 um as the light passes through the antireflection film.

Optionally, the effective reflection index of the antireflection film is greater than or equal to 1.1 and less than or equal to 2.1.

Optionally, the antireflection film is a single-layer film.

Optionally, the antireflection film is a multiple-layer film, and the materials of the multiple-layer film are different from each other, or parts of the layers in the multiple-layer film are made of different materials.

Optionally, the material of the antireflection film includes: any one or more of zinc sulfide, zinc fluoride, magnesium fluoride, silica, and titanium dioxide;
and the material of the substrate comprises silicon.

Optionally, the negative nanostructures are any one or more of cylindrical space, elliptical column space, rectangular column space, square column space, cross column space.

Optionally, the interior of each of the plurality of the negative nanostructures comprises an inner nanostructure, and the inner nanostructure extends from the bottom of the negative nanostructure and aligns with the side surface of the substrate;

Optionally, the material of the inner nanostructure and the substrate is the same, and the shape of the inner nanostructure is any one or more of columns, elliptical column, rectangular column, square column, cross column.

In the second aspect, a design method for a metasurface is provided, the design method for a metasurface can be implemented to the metasurface, and the design method for a metasurface includes:
setting a target transmittance for the metasurface;
inputting and optimizing the refractive index and the thickness of the antireflection film, till obtaining a first transmittance of the metasurface covered with an antireflection film according to the refractive index and the thickness of the metasurface, and the difference between the first transmittance and the target transmittance is less than or equal to the pre-set value;
outputting an optimized refractive index of the antireflection film and an optimized thickness of the metasurface;
selecting a matching material for the antireflection film in the material database, and the difference between the refractive index of the matching material for the antireflection film and the refractive index of the optimized antireflection film is minimum;
calculating a second transmittance of the metasurface covered with the antireflection film according to the refractive index and the optimized antireflection film;
determining whether the difference between the second transmittance and the target transmittance is less than or equal to the pre-set value;
if the difference between the second transmittance and the target transmittance is less than or equal to the pre-set value, then outputting the matching material for the antireflection film and the optimized thickness of the antireflection film;
if the difference between the second transmittance and the target transmittance is greater to the pre-set value, then re-optimizing the optimized thickness of the antireflection film, and calculating a third transmittance of the metasurface for the antireflection film according to the refractive index of the matching material for the antireflection film and the re-optimized thickness of the antireflection film, till the difference between the third transmittance and the target transmittance is less than or equal to the pre-set value.

Optionally, the pre-set value is less than or equal to 3%.

Optionally, the pre-set value is less than or equal to 1%.

Optionally, before the step “inputting and optimizing the refractive index and the thickness of the antireflection film”, the design method for a metasurface includes:
inputting a parameter of the structure, and the parameter of the structure comprises: the working waveband of the metasurface, and the periodicity and depth of the negative nanostructure.

In the third aspect, a design device for a metasurface is provided, and the design device for a metasurface is used to implement the design method, and the design device includes:
an optimizing module, the optimizing module is used to input and optimize the refractive index and the thickness of the antireflection film;
a matching module, the matching module is used to select a matching material for the antireflection film, and the difference between the refractive index of the material of the matching layers and the optimized refractive index of the antireflection film;
a calculating module, the calculating module is used to calculate the transmittance of the metasurface covered with the antireflection film;
a determining module, the determining module is used to determine whether the difference between the transmittance obtained by calculation and the target transmittance is less than or equal to the pre-set value.

In the fourth aspect, an electronic device is provided, the electronic device includes: a bus, a transceiver, a memory, a processor and a computer program;
the computer program is stored in the memory and executable on the processor; the transceiver, the memory and the processor are connected through the bus; the computer program is executed by the processor, so as to implement the design method.

In the fifth aspect, a non-transitory computer-readable storage medium, the non-transitory computer-readable storage medium in which a computer program is stored, wherein the computer program is executed by a processor, so as to implement the design method.

In the sixth aspect, a fabrication method for a metasurface is provided, the fabrication method for the metasurface is used to fabricate the metasurface, and the fabrication method for the metasurface includes:
S1. preparing the substrate;
S2. covering the antireflection film material on the substrate, and obtaining the substrate covered with the antireflection film material;
S3. performing optical lithography and etching on the one side of the substrate covered with the antireflection film material, so as to obtain the metasurface covered with the antireflection film.

The metasurface, the design method, the design device, the electronic device, and the fabrication method provide the negative nanostructure metasurface with the antireflection film, which is able to improve the transmittance of the electromagnetic wave in the working waveband while realizing the original functions of the metasurface, thus improving the optical efficiency of the optical system. Next, the design method provided by the present disclosure uses iterative optimization to improve the transmittance and the workability of the negative nanostructure metasurface with the antireflection film. The iterative optimization is based on the prior art of the optimization algorithm for the antireflection film to re-optimize the parameters of the optimized refractive index and the thickness. After obtaining the parameters of the optimized refractive index and the optimized thickness, the difference between the optimized refractive index and the antireflection film material will be further considered, and then the parameters of the optimized thickness will be decided to be further optimized. In addition, a fabrication method for a metasurface is provided by the embodiment of the present disclosure. Compared with the fabrication method for the positive nanostructure metasurface with the antireflection film, the fabrication method provided in this disclosure coats the antireflection film material before fabrication, then exposes and etches the whole substrate, which simplifies the fabrication, thus saving the fabrication time and improves the overall production yield.

### BRIEF DESCRIPTION OF THE DRAWINGS

In order to explain more clearly, the technical scheme in the application technology or the background technology, the attached drawings required in the application embodiment or the background technology will be explained below.

FIG. 1 is an entire schematic diagram of a metalens covered with an antireflection film.

FIG. 2 is a partial section view of a metasurface covered with an antireflection film of FIG. 1.

FIG. 3A is a top view of the metasurface provided with the present embodiment, and the metasurface includes a negative nanostructure with the spatial shape of a cross column.

FIG. 3B is a top view of the metasurface provided with the present embodiment, and parts of the negative nanostructures are with the spatial shape of a square column and parts of the negative nanostructures are with the spatial shape of a cylindrical space.

FIG. 4A is a side section view of a metasurface covered with an antireflection film without the inner nanostructures.

FIG. 4B is a side section view of the inner nanostructures within the negative nanostructures of the metasurface covered with an antireflection film.

FIG. 5 is a top view of the metasurface with the antireflection film, and the metasurface includes the negative nanostructures with the inner nanostructures.

FIG. 6 shows the changes of the transmittance of the metasurface with or without the antireflection film in the waveband of 8-12 um in Embodiment 1.

FIG. 7 shows the changes of the transmittance of the metasurface with the antireflection film in Embodiment 1 and Comparison 1 in the waveband of 8-12 um.

FIG. 8 shows the changes of the transmittance of the metasurface with or without the antireflection film in the waveband of 8-12 um in Embodiment 2.

FIG. 9 shows the changes of the transmittance of the metasurface with the antireflection film in Embodiment 2 and Comparison 2 in the waveband of 8-12 um.

FIG. 10 shows the changes of the transmittance of the metasurface with the antireflection film in Embodiment 3 and Comparison 3 in the waveband of 8-12 um.

FIG. 11 shows the changes of the transmittance of the metasurface with the antireflection film in Embodiment 3 and Comparison 3 in the waveband of 8-12 um.

FIG. 12 shows the changes of the transmittance of the metasurface with the antireflection film in Embodiments 1-3 in the waveband of 8-12 um.

FIG. 13 shows the changes of the transmittance of the metasurface with the antireflection film in Embodiment 6 in the waveband of 3-5 um.

FIG. 14 shows the changes of the transmittance of the metasurface with the antireflection film in Embodiment 6 and Comparison 3 in the waveband of 3-5 um.

FIG. 15 shows an optional flow chart of the design method for the metasurface.

FIG. 16 shows an optional flow chart of the design method for the metasurface.

FIG. 17 shows an electronic device used to implement the design method for the metasurface.

### DETAILED DESCRIPTION OF DISCLOSURED EMBODIMENTS

An embodiment will be described in detail below, the examples of which are represented in the accompanying drawings. When the following description involves the drawings, the same numbers in different drawings indicate the same or similar elements unless otherwise indicated. The embodiments described in the following exemplary embodiment do not represent all embodiments consistent with the present disclosure. Instead, they are only examples of devices and methods consistent with some aspects of the present disclosure, as detailed in the attached claim.

The term used in the disclosure is solely for the purpose of describing a specific embodiment and not to restrict the disclosure. “One”, “described”, “and” “this” of the singular forms used in the present application and the attached claims are also intended to include a majority form unless the context clearly indicates other meanings. It should also be understood that the term “and/or” used in this article means and contains any or all possible combinations of one or more associated listed items.

It should be understood that although the terms “first, second, and third, etc.” may be used to describe various information, such information should not be limited to these terms. These terms are used only to separate the same type of information from each other. For example, without leaving the scope of the present disclosure, the first information may also be referred to as second information, and similarly, the second information may also be referred to as first information. Depending on the context, the word “if” used here can be interpreted as “when . . . ” or “while . . . ” or “responsive to the certainty”. In the case of no conflict, the following embodiment and the embodiments may be combined with each other.

It should be noted that the negative nanostructure metasurface of this disclosure is completely different from the conventional positive nanostructure metasurface. For the positive nanostructure metasurface, the positive nanostructure is set on the surface of the substrate, and the material of the positive nanostructure can be the same as the substrate material, and the gap between the nanostructures can be filled with air or a filler material with high transmittance at the working wavelength. For the negative nanostructure metasurface, a plurality of nanopores is provided on the substrate surface, and each of the plurality of nanopores is a negative nanostructure. The negative nanostructure can be filled with air or a filler material with high transmittance at the working wavelength. Compared with the positive nanostructure metasurface, the effective refractive index of the negative nanostructure metasurface is greater, that is, the difference between the effective refractive index of the air and the effective refractive index of the negative nanostructure is larger, but the difference the effective refractive index of the substrate and the effective refractive index of the negative nanostructure is smaller. The transmittance of light passing through the negative structure metasurface is more affected by the transmittance of the interface between the metasurface and air, that is, the requirement for improving the transmittance is higher.

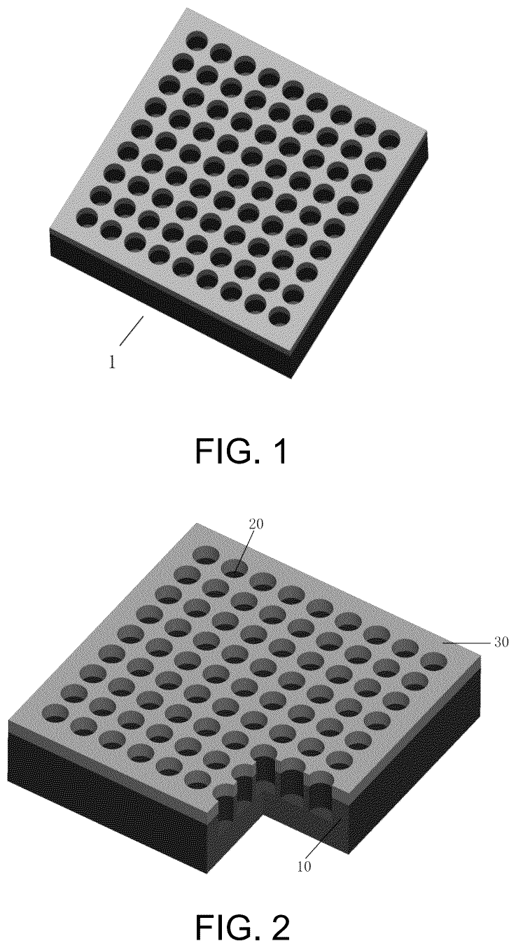

FIG. 1 is a three-dimensional view of the negative nanostructure metasurface with an antireflection film, and FIG. 2 is a sectional view of the structure of FIG. 1. A metasurface 1 provided by the embodiment of the present disclosure is shown in FIG. 1 and FIG. 2, and the metasurface 1 includes: a substrate 10. The substrate 10 includes a first side 101. And the first side 101 of the substrate 10 has a plurality of negative nanostructures 20 at different locations, and the depth of the plurality of negative nanostructures 20 (that is, the height of the nanostructures 20) is less than the thickness of the substrate 10; The antireflection film is covered on the surface of the first side 101 of the substrate 10 without the plurality of negative nanostructures. The transmittance of the metasurface is improved by changing the equivalent optical path as the light passing through the antireflection film, so as to improve the optical efficiency of the optical system.

In one embodiment, the gaps between the adjacent negative nanostructures may be filled with air or filler materials. The filler material includes any one or more of barium fluoride, alumina, and silica. Optionally, when the working waveband is far-infrared waveband, the filler material may include barium fluoride. When the working waveband is mid-infrared waveband, the filler material may include alumina.

In one embodiment, the equivalent optical path is greater than or equal to 0.55 um and less than or equal to 3.36 um as the light passes through the antireflection film 30. It should be noted that the equivalent optical path that the light passing through the antireflection film 30 is equal to the product of the thickness of the antireflection film 30 and the effective refractive index of the antireflection film 30 in the working waveband. For the traditional antireflection film, when the light is transporting in the antireflection film, the reflection will happen on the both inner surfaces. When the difference between the optical paths of the inner surfaces is equal to half of the wavelength, the destructive interference will happen to the reflective lights of both inner surfaces, that is the energy of the transmittive light is increasing and the transmittance is improved. The applicants found that when the equivalent optical path is greater than or equal to 0.55 um and less than or equal to 3.36 um as the light passes through the antireflection film 30, the transmittance of the metasurface covered with the antireflection film within the above range is greater than the transmittance of the metasurface covered with the antireflection film outside the above range. That is to say, when the equivalent optical path is greater than or equal to 0.55 um and less than or equal to 3.36 um as the light passes through the antireflection film 30, the transmittance increases.

In one embodiment, when the working waveband is the far-infrared band, the equivalent optical path is greater than or equal to 0.99 um and less than or equal to 3.66 um as the light passes through the antireflection film 30. Preferably, the equivalent optical path is greater than or equal to 1.44 um and less than or equal to 3.2 um as the light passes through the antireflection film.

Optionally, the range of the far-infrared band is from 8 um to 12 um, and the range of the depth of the plurality of the negative nanostructures is from 10 um to 12 um, and when the antireflection film is a single-layer film, the range of the thickness of the antireflection film is from 900 nm to 2.0 um. Preferably, the thickness of the antireflection film is 1.3 um. Preferably, the material of the antireflection film 30 is zinc sulfide.

In one embodiment, the working waveband of the metasurface is the mid-infrared waveband, and the equivalent optical path is greater than or equal to 0.55 um and less than or equal to 2.52 um as the light passes through the antireflection film. Preferably, the equivalent optical path is greater than or equal to 0.8 um and less than or equal to 2.4 um as the light passes through the antireflection film 30.

Optionally, the range of the mid-infrared waveband is from 3 um to 5 um, and the range of the depth of the plurality of the negative nanostructures is from 5 um to 8 um, and when the antireflection film is a single-layer film, the range of the thickness of the antireflection film is from 500 nm to 1.2 um.

In one embodiment, the equivalent optical path is greater than or equal to 15 um and less than or equal to 40.2 um as the light passes through the negative nanostructures 20.

In one embodiment, the antireflection film is a single-layer film.

In one embodiment, the antireflection film is a multiple-layer film, and the materials of the multiple-layer film are different from each other, or parts of the layers in the multiple-layer film are made of different materials.

In one embodiment, the material of the antireflection film includes: any one or more of zinc sulfide, zinc fluoride, magnesium fluoride, silica, and titanium dioxide.

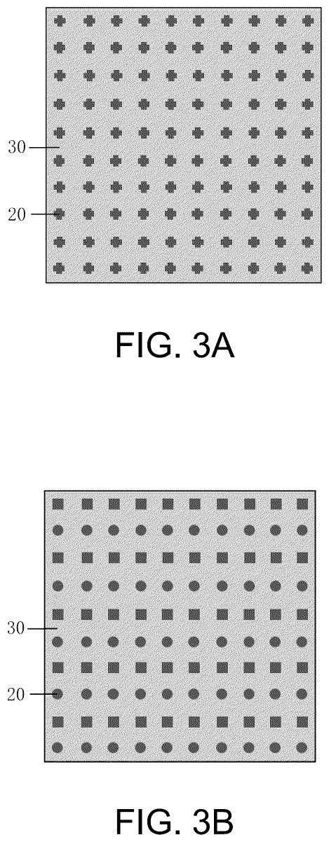

FIG. 1 and FIG. 2 show the cylindrical nanopore, and the nanopores are the negative nanostructures. In other words, the plurality of negative nanostructures are shown as cylindrical space. In one embodiment, the plurality of negative nanostructures may be any one or more of cylindrical space, elliptical column space, rectangular column space, square column space, cross column space. For example, the FIG. 3A is a top view of the plurality of negative nanostructures as cross column spaces. FIG. 3B is a top view of the plurality of negative nanostructures, and the parts of the negative nanostructures are rectangular column space and parts of the negative nanostructures are elliptical column space.

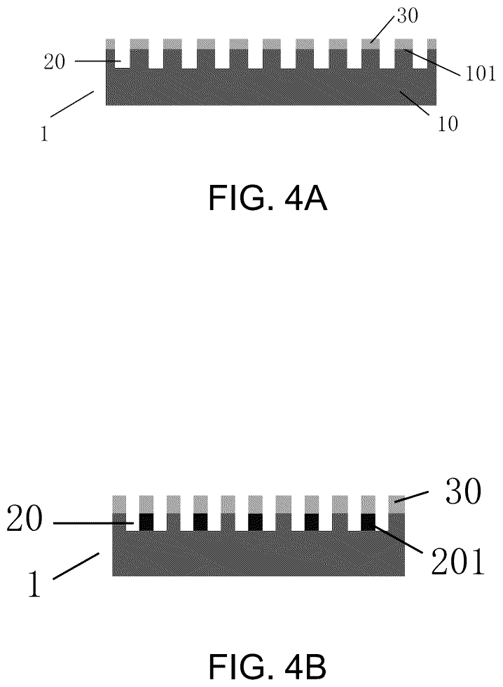

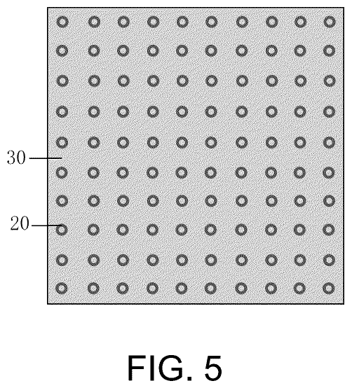

In one embodiment, the negative nanostructures includes an inner nanostructure 201, and the inner nanostructure 201 extends from the bottom of the negative nanostructure 20 and aligns with the side surface 101 of the substrate 10. The material of the inner nanostructure 201 and the substrate 10 is the same, and the shape of the inner nanostructure 201 is any one or more of column, elliptical column, rectangular column, square column, cross column. In one embodiment, FIG. 4A shows a side view of the negative nanostructures 20 without the inner nanostructure 201. FIG. 4B and FIG. 5 shows an embodiment of the negative nanostructures 20 within the inner nanostructure 201 as a side view and a top view, respectively. FIG. 4B is a side view of an embodiment of the negative nanostructures 20 within the inner nanostructure 201. FIG. 5 is a top view of an embodiment of the negative nanostructures 20 within the inner nanostructure 201. In one embodiment, the antireflection film is covered on the top surface of the inner nanostructures as shown in FIG. 4B.

In one embodiment, the material of the antireflection film 30 is zinc sulfide, and the plurality negative nanostructures are filled with air. The air and the antireflection film 30 are even, so as to form a flat plane. And the effective reflection index of the flat plane is greater than or equal to 1.1 and less than or equal to 2.1, which means the effective reflection index of the antireflection film 30 is greater than or equal to 1.1 and less than or equal to 2.1 within the working waveband. Preferably, the effective refractive index of the antireflection film 30 is greater than or equal to 1.6 and less than or equal to 2 in the working waveband.

In one embodiment, the material of the substrate 10 includes silicon, and the plurality negative nanostructures 20 are filled with air. The effective refractive index of the substrate 10 and the nanostructures 20 filled with air is greater than or equal to 1.5, and is less than or equal to 2.1 at the working wavelength. Preferably, the effective refractive index of the substrate 10 and the nanostructures 20 filled with air is greater than or equal to 2.2, and is less than or equal to 3.16 at the working wavelength.

### Embodiment 1

A metasurface 1 is working at a waveband of 8-12 um. The metasurface 1 includes: a substrate 10. The first side 101 of the substrate 10 has a plurality of negative nanostructures 20 at different locations, and the depth of the plurality of negative nanostructures 20 is less than the thickness of the substrate 101. The radius of each negative nanostructures 20 is greater than or equal to 0.25 um, and less than or equal to 0.45 um. The height of each nanostructure 20 is 11 um. The plurality of negative nanostructures 20 are periodically arranged, and the periodicity of the plurality of negative nanostructures 20 is 3 um. The gaps between the adjacent negative nanostructures 20 are filled with air. The material of the substrate 10 is monocrystalline silicon.

The metasurface 1 is covered with the antireflection 30. The antireflection film is covered on the surface of the first side 101 of the substrate 10 without the plurality of negative nanostructures. The material of the antireflection film 30 is zinc sulfide. The interval of the refractive index of the zinc sulfide is [2.17, 2.22], and the average of refractive index is about 2.2 in the waveband of 8-12 um. In a plat layer composed of air and the antireflection film, the interval of the duty cycle of the antireflection film is [0.5,0.99], and the effective refractive index of the plat layer composed of air and the antireflection film is about 1.65 in waveband of 8-12 um. The plat layer is a three-dimensional structure, and has the same thickness as the antireflection film 30. The thickness of the antireflection film is 1.25351 um. Therefore, the equivalent optical path of the antireflection film 30 as the light pass through the antireflection film is 1.65×1.25351=2.07 um.

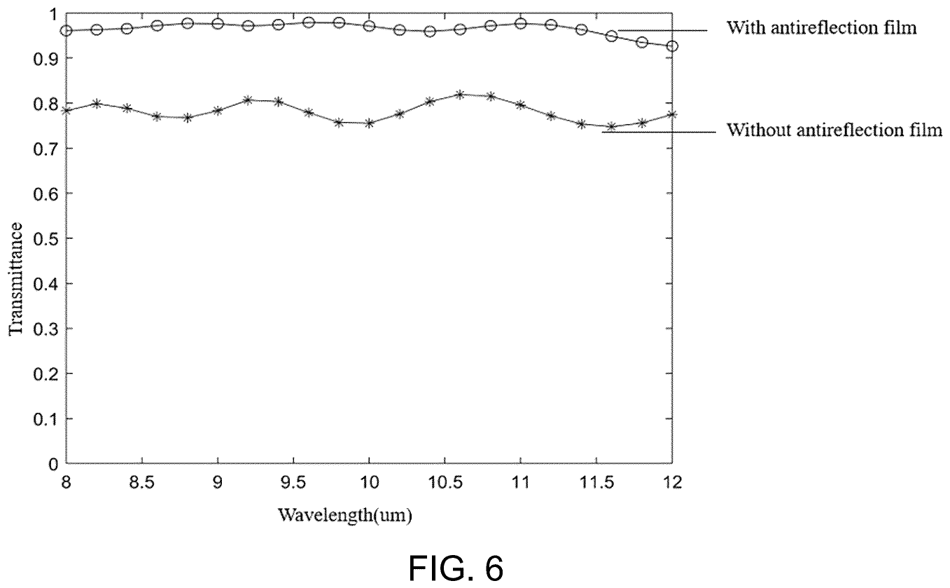

The parameters of the metasurface covered with the antireflection film is shown in Table 1. The parameters may be calculated by FDTD (Finite Difference Time Domain), so as to obtain the transmittance of the metasurface that is covered with the antireflection film and the transmittance of the metasurface without the antireflection film. The results of the transmittance is shown in FIG. 6, and FIG. 6 shows the relationship between the transmittance and wavelength of two metasurfaces with or without the antireflection film in the waveband of 8-12 um. As can be seen from FIG. 6, the transmittance of the metasurface with the antireflection film is much greater than the transmittance of the metasurface without the antireflection film at any wavelength. The average transmittance of the metasurface without the antireflection film is only 78.12% in the waveband of 8-12 um, and the average transmittance of the metasurface covered with the antireflection film is 96.42%. The average transmittance of the negative structure metasurface covered with the antireflection film is greater than the average transmittance of the negative structure metasurface without the antireflection film.

TABLE 1

| Parameters of | Periodicity | 3 | um |
|---|---|---|---|
| the negative | Range of radius | 0.25-0.45 | um |
| structures | Height | 11 | um |
| | Filler material | Air | |
| Parameters of | Substrate | Monocrystalline | |
| metasurface | | silicon | |
| | Working wavelength | 8-12 | um |
| Parameters of | Material | Zinc sulfide | |
| antireflection | Thickness | 1.25351 | um |

| | | |
|---|---|---|
| film | Average of refractive | 2.2 |
| | index in working | |
| | waveband | |
| | Effective refractive | 1.65 |
| | index in working | |
| | waveband | |

### Comparison 1

The parameters of the metasurface 1 in the Comparison 1 are consistent with Embodiment 1, the only difference is the equivalent optical path is 3.39 um as the light passes through the antireflection film. Specifically, the material of the antireflection film 30 is zinc sulfide with a thickness of 2.05455 um.

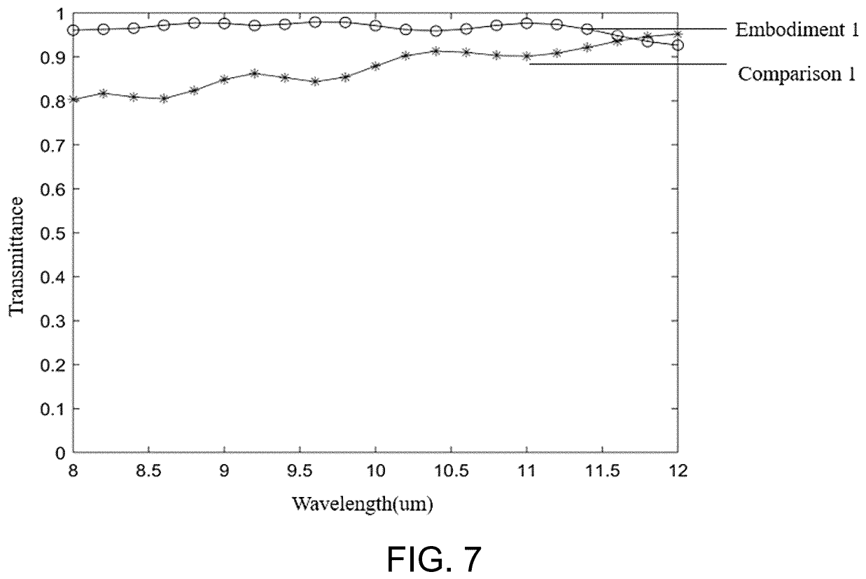

The transmittance of the metasurface that is covered with the antireflection film in Embodiment 1 and the transmittance of the metasurface that is covered with the antireflection film in Comparison 1 may be calculated by FDTD and the parameters. The results are shown in FIG. 7. FIG. 7 shows the relationship between the transmittance and wavelength of two metasurfaces. The average transmittance of the metasurface in Comparison 1 is only 87.60% in the waveband of 8-12 um, and the average transmittance of the metasurface in Embodiment is 96.42%. Therefore, the average transmittance of the metasurface with the antireflection film in Embodiment 1 is greater than the average of the transmittance of the metasurface with the antireflection film in Comparison 1.

### Embodiment 2

A metasurface 1 is working at a waveband of 8-12 um. The metasurface 1 includes: a substrate 10. The first side 101 of substrate 10 has a plurality of negative nanostructures 20 at different locations. The radius of each negative nanostructure 20 is greater than or equal to 0.25 um, and less than or equal to 0.45 um. The height of each nanostructure 20 is 8 um. The plurality of negative nanostructures 20 are periodically arranged, and the periodicity of the plurality of negative nanostructures 20 is 2.5 um. The plurality of negative nanostructures 20 are filled with air. The material of the substrate 10 is monocrystalline silicon.

The metasurface 1 is covered with the antireflection 30. The antireflection film is covered on the surface of the first side 101 of the substrate 10 without the plurality of negative nanostructures. The material of the antireflection film 30 is zinc sulfide. The interval of the refractive index of the zinc sulfide is [2.17, 2.22], and the average refractive index is about 2.2 in the waveband of 8-12 um. In the plat layer composed of air and the antireflection film, the interval of the duty cycle of the antireflection film is [0.5,0.99], and the effective refractive index of the plat layer composed of air and the antireflection film in waveband of 8-12 um is about 1.65. The thickness of the antireflection film is 1.34636 um. Therefore, the equivalent optical path of the antireflection film 30 as the light pass through the antireflection film is 1.65×1.34636=2.22 um.

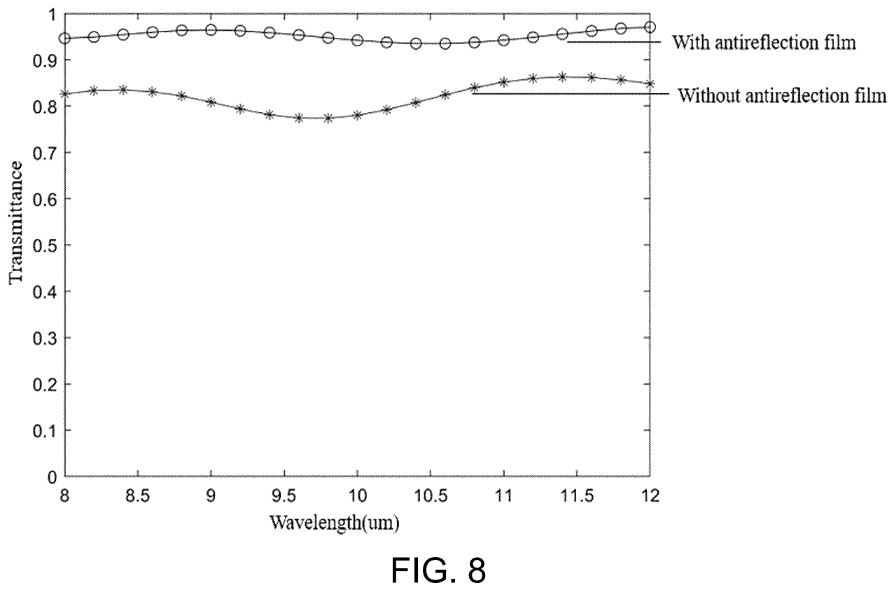

The parameters of the metasurface covered with the antireflection film is shown in Table 2. The parameters may be calculated by FDTD (Finite Difference Time Domain), so as to obtain the transmittance of the metasurface that is covered with the antireflection film and the transmittance of the metasurface without the antireflection film. The results of the transmittance is shown in FIG. 8, and FIG. 8 shows the relationship between the transmittance and wavelength of two metasurfaces with or without the antireflection film in the waveband of 8-12 um. As can be seen from FIG. 8, the transmittance of the metasurface with the antireflection film is much greater than the transmittance of the metasurface without the antireflection film at any wavelength. The average transmittance of the metasurface without the antireflection film is only 82.22% in the waveband of 8-12 um, and the average transmittance of the metasurface covered with the antireflection film is 95.21%. The average transmittance of the negative structure metasurface covered with the antireflection film is greater than the transmittance of the negative structure metasurface without the antireflection film.

TABLE 2

| Parameters of | Periodicity | 2.5 | um |
|---|---|---|---|
| the negative | Range of radius | 0.25-0.45 | um |
| structures | Height | 8 | um |
| | Filler material | Air | |
| Parameters of | Substrate | Monocrystalline | |
| metasurface | | silicon | |
| | Working wavelength | 8-12 | um |
| Parameters of | Material | Zinc sulfide | |
| antireflection | Thickness | 1.34636 | um |

| | | |
|---|---|---|
| film | Average of refractive | 2.2 |
| | index in working | |
| | waveband | |
| | Effective refractive | 1.65 |
| | index in working | |
| | waveband | |

### Comparison 2

The parameters of the metasurface 1 in the Comparison 2 are consistent with Embodiment 1, the only difference is the equivalent optical path is 3.41 um as the light passes through the antireflection film. Specifically, the material of the antireflection film 30 is zinc sulfide with a thickness of 2.06667 um.

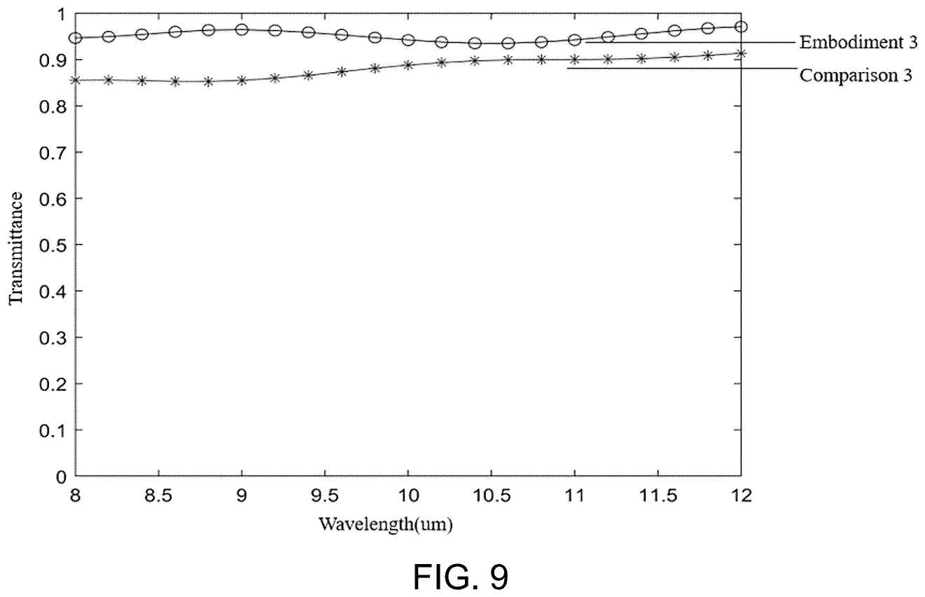

The transmittance of the metasurface that is covered with the antireflection film in Embodiment 1 and the transmittance of the metasurface that is covered with the antireflection film in Comparison 1 may be calculated by FDTD and the parameters. The results are shown in FIG. 9. FIG. 9 shows the relationship between the transmittance and wavelength of two metasurfaces. The average transmittance of the metasurface in Comparison 1 is only 88.17% at the waveband of 8-12 um, and the average transmittance of the metasurface in Embodiment is 95.21%.

### Embodiment 3

A metasurface 1 is working at a waveband of 8-12 um. The metasurface 1 includes: a substrate 10. The first side 101 of substrate 10 has a plurality of negative nanostructures 20 at different locations. The radius of each negative nanostructure 20 is greater than or equal to 0.25 um, and less than or equal to 0.45 um. The height of each nanostructure 20 is 8 um. The plurality of negative nanostructures 20 are periodically arranged, and the periodicity of negative nanostructures 20 is 2.5 um. The plurality of negative nanostructures 20 are filled with air. The material of the substrate 10 is monocrystalline silicon.

The metasurface 1 is covered with the antireflection 30. The antireflection film is covered on the surface of the first side 101 of the substrate 10 without the plurality of negative nanostructures. The antireflection film 30 includes a first layer and a second layer. The first layer and the second layer are sequentially stacked in a direction away from the substrate 10. The material of the first layer is yttrium fluoride. The refractive index of the yttrium fluoride is 1.3 in the waveband of 8-12 um. In the plat layer composed of air and the antireflection film 30, the interval of the duty cycle of the antireflection film is [0.5,0.99], and the effective refractive index of the first layer in the waveband of 8-12 um is about 0.975. The thickness of the first layer is 0.99 um. Therefore, the equivalent optical path of the first layer is 0.975×0.99=0.97 um as the light pass through the second layer. The material of the second layer is zinc sulfide, and the range of the refractive index of the zinc sulfide is [2.17, 2.22] in the waveband of 8-12 um. And the average effective refractive index of the second layer in the waveband of 8-12 um is about 2.2. In the plat layer composed of air and the antireflection film 30, the interval of the duty cycle of the antireflection film is [0.5,0.99], and the effective refractive index of the second layer in the waveband of 8-12 um is about 1.65. The thickness of the second layer is 0.99 um. Therefore, the equivalent optical path of the second layer is 1.65×0.99=1.63 um as the light pass through the second layer. In conclusion, in Embodiment 3 the equivalent optical path of the antireflection film 30 as the light pass through the antireflection film is 0.97+1.63=2.60 um.

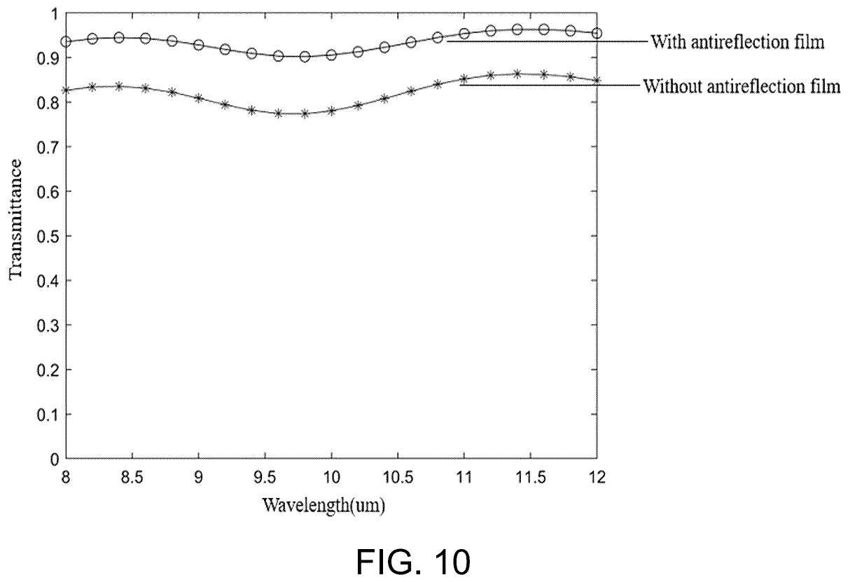

The parameters of the metasurface covered with the antireflection film is shown in Table 3. The parameters may be calculated by FDTD (Finite Difference Time Domain), so as to obtain the transmittance of the metasurface covered with the antireflection film and the transmittance of the metasurface without the antireflection film. The results of the transmittance are shown in FIG. 10, and FIG. 10 shows the relationship between the transmittance and wavelength of two metasurfaces with or without the antireflection film in the waveband of 8-12 um. As can be seen from FIG. 10, the transmittance of the metasurface with the antireflection film is much greater than the transmittance of the metasurface without the antireflection film at any wavelength. The average transmittance of the metasurface without the antireflection film is only 82.22% in the waveband of 8-12 um, and the average transmittance of the metasurface covered with the antireflection film is 93.49%. The average transmittance of the negative structure metasurface covered with the antireflection film is greater than the transmittance of the negative structure metasurface without the antireflection film.

TABLE 3

| Parameters of | Periodicity | 2.5 | um |
|---|---|---|---|
| the negative | Range of radius | 0.25-0.45 | um |
| structures | Height | 8 | um |
| | Filler material | Air | |
| Parameters of | Substrate | Monocrystalline | |
| metasurface | | silicon | |
| | Working wavelength | 8-12 | um |
| Parameters of | Material of the first layer | Yttrium fluoride | |
| antireflection | Thickness of the first layer | 0.99 | um |
| film | Average of refractive index | 1.3 | |
| | of the first layer in working | | |
| | waveband | | |
| | Effective refractive index | 0.975 | |
| | of the first layer in working | | |
| | waveband | | |
| | Material of the second | Zinc sulfide | |
| | layer | | |
| | Thickness of the second | 0.99 | um |

| | |
|---|---|
| layer | |
| Average of refractive index | 2.2 |
| of the second layer in | |
| working waveband | |
| Effective refractive index | 1.65 |
| of the second layer in | |
| working waveband | |

### Comparison 3

The parameters of the metasurface 1 in the Comparison 3 are consistent with Embodiment 3, the only difference is the equivalent optical path is 0.73 um as the light passes through the antireflection film. Specifically, the material of the first layer is yttrium fluoride with a thickness of 0.30215 um. The material of the second layer is zinc sulfide with a thickness of 0.26107 um.

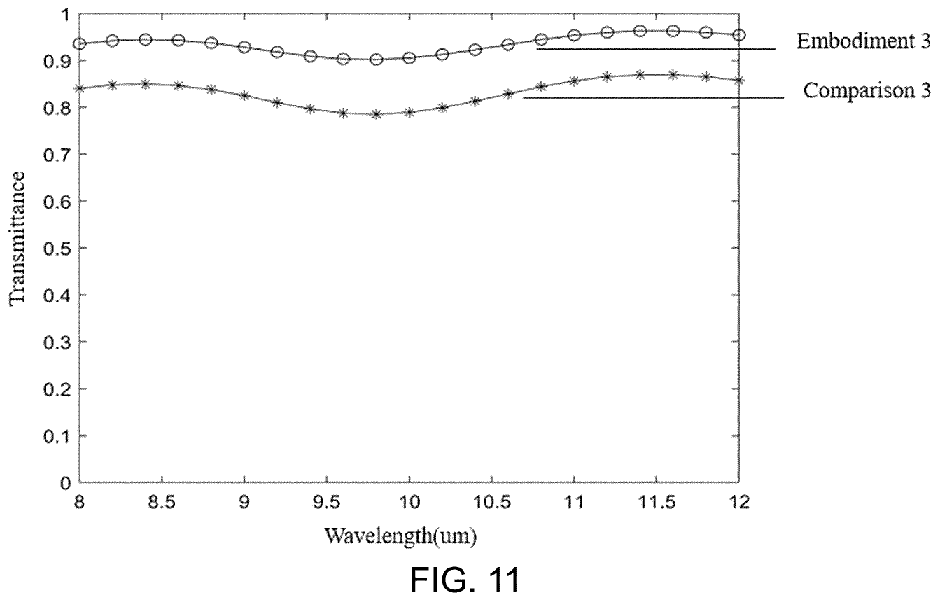

The transmittance of the metasurface covered with the antireflection film in Embodiment 3 and the transmittance of the metasurface covered with the antireflection film in Comparison 3 may be calculated by FDTD and the parameters. The results are shown in FIG. 11. FIG. 11 shows the relationship between the transmittance and wavelength of two metasurfaces. The average transmittance of the metasurface in Comparison 3 is only 83.26% in the waveband of 8-12 um, and the average transmittance of the metasurface in Embodiment is 93.49%.

### Embodiment 4

The parameters of the metasurface 1 in Embodiment 4 are consistent with Embodiment 2, the only difference is the equivalent optical path is 3.16 um as the light passes through the antireflection film. Specifically, the material of the first layer is zinc sulfide with a thickness of 1.91515 um.

The parameters may be calculated by FDTD (Finite Difference Time Domain), so as to obtain the transmittance of the metasurface covered with the antireflection film and the transmittance of the metasurface without the antireflection film. The average transmittance of the metasurface without the antireflection film is only 82.22% in the waveband of 8-12 um, and the average transmittance of the metasurface covered with the antireflection film is 94.60%. The average transmittance of the negative structure metasurface covered with the antireflection film is greater than the transmittance of the negative structure metasurface without the antireflection film.

### Comparison 4

The parameters of the metasurface 1 in the Comparison 4 are consistent with Embodiment 4, the only difference is the equivalent optical path is 3.49 um as the light passes through the antireflection film. Specifically, the material of the antireflection film is zinc sulfide with a thickness of 2.11515 um.

The transmittance of the metasurface covered with the antireflection film in Embodiment 4 and the transmittance of the metasurface covered with the antireflection film in Comparison 4 may be calculated by FDTD and the parameters. The average transmittance of the metasurface in Comparison 4 is only 84.65% in the waveband of 8-12 um, and the average transmittance of the metasurface in Embodiment 4 is 94.60%.

### Embodiment 5

The parameters of the metasurface 1 in the Embodiment 5 are consistent with Embodiment 2, the only difference is the equivalent optical path is 0.99 um as the light passes through the antireflection film 30. Specifically, the material of the antireflection film is zinc sulfide with a thickness of 0.6 um.

The parameters may be calculated by FDTD (Finite Difference Time Domain), so as to obtain the transmittance of the metasurface covered with the antireflection film and the transmittance of the metasurface without the antireflection film. The average transmittance of the metasurface without the antireflection film is only 82.22% in the waveband of 8-12 um, and the average transmittance of the metasurface covered with the antireflection film is 96.37%. The average transmittance of the negative structure metasurface covered with the antireflection film is greater than the transmittance of the negative structure metasurface without the antireflection film.

### Comparison 5

The parameters of the metasurface 1 in the Comparison 5 are consistent with Embodiment 5, the only difference is the equivalent optical path is 0.95 um as the light passes through the antireflection film. Specifically, the material of the antireflection film is zinc sulfide with a thickness of 0.57576 um.

The transmittance of the metasurface covered with the antireflection film in Embodiment 5 and the transmittance of the metasurface covered with the antireflection film in Comparison 5 may be calculated by FDTD and the parameters. The average transmittance of the metasurface in Comparison 5 is only 85.35% in the waveband of 8-12 um, and the average transmittance of the metasurface in Embodiment 5 is 96.37%.

The embodiments 1-5 and the comparisons 1-5 show the metasurface covered with antireflection film in far-infrared waveband. In far-infrared waveband, the transmittances of metasurface with antireflection film or without antireflection film in embodiments and comparisons are shown in Table 4. As can be seen from Table 4, the transmittance of the metasurface with antireflection film 30 improves greatly. Moreover, when the equivalent optical path is within the range [0.99, 3.36] as the light passes through the antireflection film, the transmittance of the metasurface with the antireflection film is within the interval of (90%, 100%). When the transmittance of the light is outside the range [0.99,3.36], the transmittance of the metasurface with the antireflection film is within the interval of (80%, 90%). And the transmittance within the range of [0.99, 3.36] is higher than the transmittance outside the range. The results of the transmittance show that controlling the equivalent light path through the antireflection film in a specific range can ensure that the metasurface has a significant transmittance increasing, and the transmittance results show a correlation between the equivalent light path and the transmittance of the metasurface.

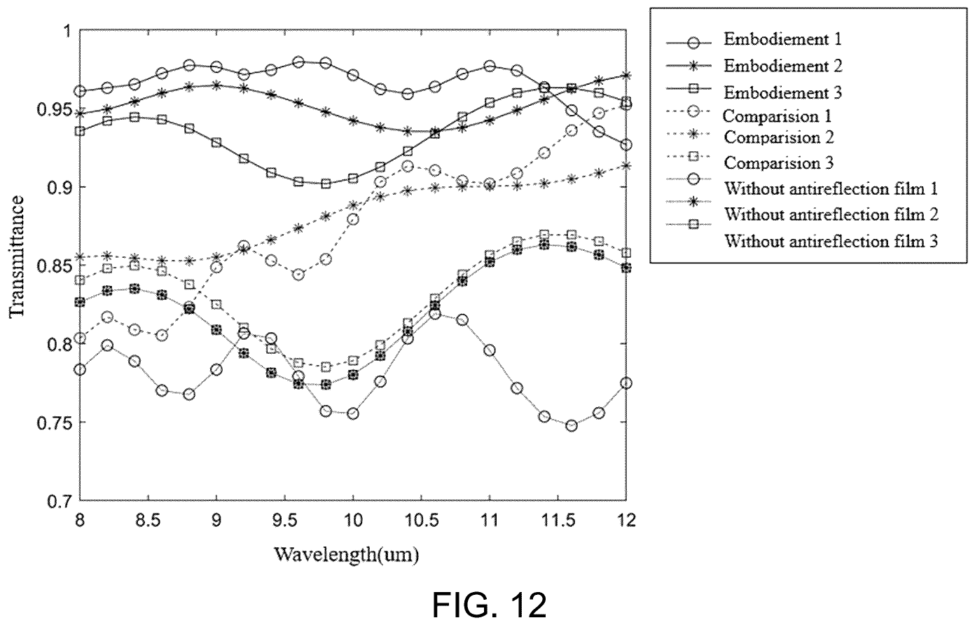

In addition, FIG. 12 shows the embodiments 1-3 of the transmittance lines of the metasurface with or without the antireflection film and the comparisons 1-3 of the transmittance lines of the metasurface with the antireflection film. It can also be seen from FIG. 12 that the equivalent optical path is within the range [0.99,3.36] as the light passes through the antireflection film, the transmittance of the metasurface with the antireflection film increases significantly, that is, the metasurface with the antireflection film shows the increase of transmittance and realizing the increasing transmittance effect of the negative structure metasurface.

TABLE 4

| Transmittance of | Embodiments 1-5 | | | |
|---|---|---|---|---|
| Embodiments 1-5 | (with antireflection film) | | Comparisons 1-5 | |
| (without antireflection | equivalent | | equivalent | |
| film) | optical path | Transmittance | optical path | Transmittance |
| 78.12% | 2.07 | 96.42% | 3.39 | 87.60% |
| 82.22% | 2.22 | 95.21% | 3.41 | 88.17% |
| 82.22% | 2.60 | 93.49% | 0.73 | 83.26% |
| 82.22% | 3.16 | 94.60% | 3.49 | 84.65% |
| 82.22% | 0.99 | 96.37% | 0.95 | 85.35% |

### Embodiment 6

A metasurface 1 is working at a waveband of 3-5 um. The metasurface 1 includes: a substrate 10. The first side 101 of the substrate 10 has a plurality of negative nanostructures 20 at different locations. The radius of each negative nanostructures 20 is greater than or equal to 0.25 um, and less than or equal to 0.45 um. The height of each nanostructure 20 is 7 um. The plurality of negative nanostructures 20 are periodically arranged, and the periodicity of the plurality of negative nanostructures 20 is 2.4 um. The plurality of negative nanostructures 20 are filled with air. The material of the substrate 10 is monocrystalline silicon.

The metasurface 1 is covered with the antireflection 30. The antireflection film 30 is covered on the surface of the first side 101 of the substrate 10 without the plurality of negative nanostructures 20. The material of the antireflection film 30 is zinc sulfide. The interval of the refractive index of the zinc sulfide is [2.247,2.258] in the waveband of 3-5 um, and the average refractive index is about 2.2525. In the plat layer composed of air and the antireflection film, the interval of the duty cycle of the antireflection film is [0.5,0.99], and the effective refractive index of the plat layer composed of air and the antireflection film in the waveband of 3-5 um is about 1.69. The thickness of the antireflection film is 0.57546 um. Therefore, the equivalent optical path of the antireflection film 30 as the light passes through the antireflection film is 1.69×0.57546-0.97253 um.

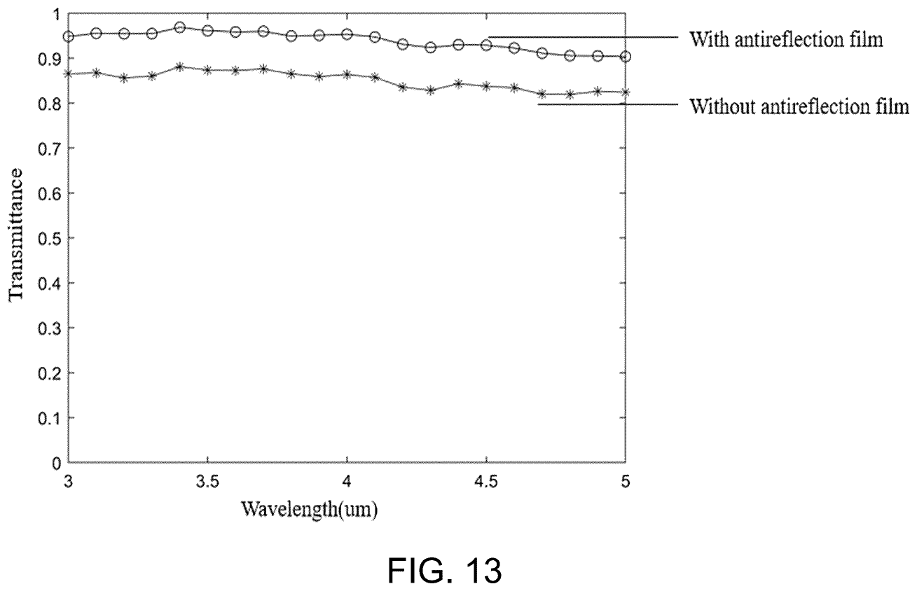

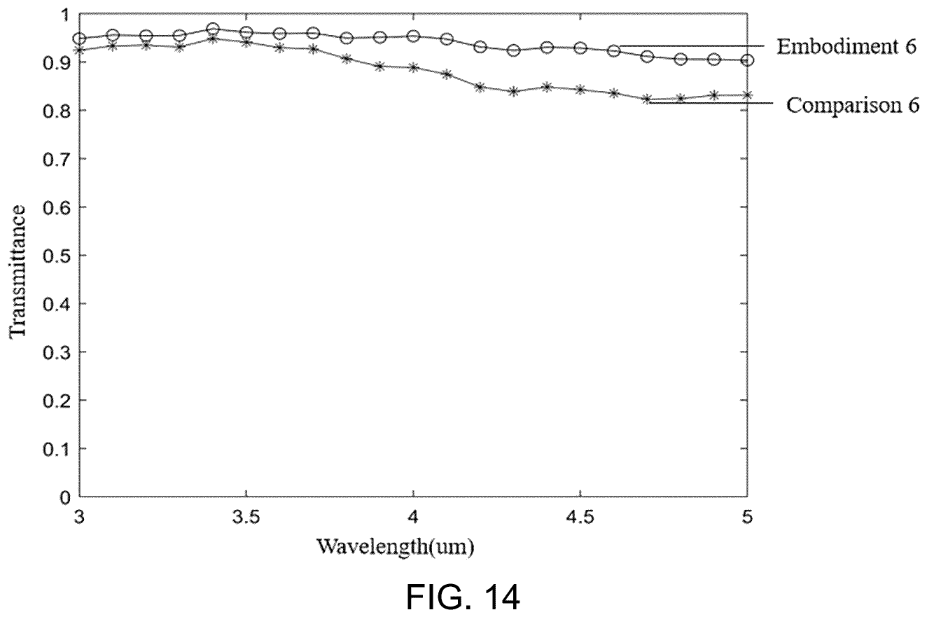

The parameters of the metasurface covered with the antireflection film are shown in Table 5. The parameters may be calculated by FDTD (Finite Difference Time Domain), so as to obtain the transmittance of the metasurface that is covered with the antireflection film and the transmittance of the metasurface without the antireflection film. The results of the transmittance are shown in FIG. 13, and FIG. 13 shows the relationship between the transmittance and wavelength of two metasurfaces with or without the antireflection film in the waveband of 3-5 um. As can be seen from FIG. 13, the transmittance of the metasurface with the antireflection film is much greater than the transmittance of the metasurface without the antireflection film at any wavelength. The average transmittance of the metasurface without the antireflection film is only 84.72% in the waveband of 3-5 um, and the average transmittance of the metasurface covered with the antireflection film is 93.93%. The average transmittance of the negative structure metasurface covered with the antireflection film is greater than the transmittance of the negative structure metasurface without the antireflection film.

TABLE 5

| Parameters | Periodicity | 2.4 | um |
|---|---|---|---|
| of the | Range of radius | 0.25-0.45 | um |
| negative | Height | 7 | um |
| structures | Filler material | Air | |
| Parameters | Substrate | Monocrystalline | |
| of the | | silicon | |
| metasurface | Working wavelength | 3-5 | um |
| Parameters | Material | Zinc sulfide | |
| of the | Thickness | 0.57546 | um |

| | | |
|---|---|---|
| antireflection | Average refractive index | 2.2525 |
| film | Effective refractive index | 1.69 |

### Comparison 6

The parameters of the metasurface 1 in Comparison 6 are consistent with Embodiment 6, the only difference is the equivalent optical path is 2.70 um as the light passes through the antireflection film. Specifically, the material of the antireflection film is zinc sulfide with a thickness of 1.59763 um.

The transmittance of the metasurface covered with the antireflection film in Embodiment 6 and the transmittance of the metasurface covered with the antireflection film in Comparison 6 may be calculated by FDTD and the parameters. The average transmittance of the metasurface in Comparison 6 is only 88.34% in the waveband of 3-5 um, and the average transmittance of the metasurface in Embodiment 4 is 93.93%.

### Embodiment 7

The parameters of the metasurface 1 in the Embodiment 7 are consistent with Embodiment 6, the only difference is the equivalent optical path is 2.40 um as the light passes through the antireflection film 30. Specifically, the antireflection film includes the first layer and the second layer. The first layer and the second layer are sequentially stacked in a direction away from the substrate 10. The material of the first layer is yttrium fluoride. The refractive index of the yttrium fluoride is 1.48 in the waveband of 3-5 um. In the plat layer composed of air and the antireflection film, the interval of the duty cycle of the antireflection film is [0.5,0.99], and the effective refractive index of the first layer in the waveband of 3-5 um is about 1.11. The thickness of the first layer is 0.69369 um. Therefore, the equivalent optical path of the first layer is 1.11×0.69369=0.77 um as the light passes through the first layer. The material of the second layer is zinc sulfide. The interval of the refractive index of the zinc sulfide is [2.247, 2.258] in the waveband of 3-5 um, and the average refractive index of the zinc sulfide is 2.2525 in the waveband of 3-5 um. In the plat layer composed of air and the antireflection film, the interval of the duty cycle of the antireflection film is [0.5,0.99], and the effective refractive index of the second layer in the waveband of 3-5 um is about 1.69. The thickness of the second layer is 0.96450 um. Therefore, the equivalent optical path of the second layer is 1.69×0.96450=1.63 um as the light passes through the first layer. In summary, the optical path of the antireflection film 30 in Embodiment 7 is 0.77+1.63=2.40 um.

The parameters may be calculated by FDTD (Finite Difference Time Domain), so as to obtain the transmittance of the metasurface with the antireflection film and the transmittance of the metasurface without the antireflection film. The results show that the average transmittance of the metasurface without the antireflection film is only 84.72% in the waveband of 3-5 um, and the average transmittance of the metasurface covered with the antireflection film is 95.86%.

### Comparison 7

The parameters of the metasurface 1 in the Comparison 6 are consistent with Embodiment 7, the only difference is the equivalent optical path is 2.59 um as the light passes through the antireflection film. Specifically, the antireflection film 30 includes the first layer and the second layer. The first layer and the second layer are sequentially stacked in a direction away from the substrate 10. The material of the first layer is yttrium fluoride and the thickness of the first layer is 0.78378 um. And material of the second layer is zinc sulfide and the thickness of the second layer is 1.01775 um.

The transmittance of the metasurface covered with the antireflection film in Embodiment 7 and the transmittance of the metasurface covered with the antireflection film in Comparison 7 may be calculated by FDTD and the parameters. The average transmittance of the metasurface with the antireflection film in Comparison 7 is only 84.92% in the waveband of 3-5 um, and the average transmittance of the metasurface in Embodiment 7 is 95.86%.

### Embodiment 8

The parameters of the metasurface 1 in Embodiment 8 are consistent with Embodiment 6, the only difference is the equivalent optical path is 1.352 um as the light passes through the antireflection film 30. Specifically, the material of the antireflection film is zinc sulfide and the thickness of the antireflection film is 0.8 um.

The parameters may be calculated by FDTD (Finite Difference Time Domain), so as to obtain the transmittance of the metasurface with the antireflection film and the transmittance of the metasurface without the antireflection film. The results of the transmittance show that the average transmittance of the metasurface without the antireflection film is only 84.72% in the waveband of 3-5 um, and the average transmittance of the metasurface covered with the antireflection film is 94.15%.

### Comparison 8

The parameters of the metasurface 1 in the Comparison 8 are consistent with Embodiment 8, the only difference is the equivalent optical path is 0.53 um as the light passes through the antireflection film. Specifically, the material of the antireflection film 30 is the zinc sulfide and the thickness of the antireflection film is 0.31361 um.

The transmittance of the metasurface covered with the antireflection film in Embodiment 8 and the transmittance of the metasurface covered with the antireflection film in Comparison 8 may be calculated by FDTD and the parameters. The average transmittance of the metasurface with the antireflection film in Comparison 8 is only 87.66% in the waveband of 3-5 um, and the average transmittance of the metasurface in Embodiment 8 is 94.15%.

The embodiments 6-8 and Comparisons 6-8 show the metasurface covered with antireflection film in a mid-infrared waveband. In the mid-infrared waveband, the transmittances of metasurface with antireflection film or without antireflection film in embodiments and comparisons are shown in Table 6. As can be seen from Table 6, the transmittance of the metasurface with antireflection film 30 improves greatly. Moreover, when the equivalent optical path is within the range [0.55, 2.52] as the light passes through the antireflection film, the transmittance of the metasurface with the antireflection film is within the interval of (90%, 100%). When the transmittance of the light is outside the range [0.55,2.52], the transmittance of the metasurface with the antireflection film is within the interval of (80%, 90%). And the transmittance within the range of [0.55, 2.52] is higher than the transmittance outside the range. The results of the transmittance show that the regulation of the equivalent light path through the antireflection film in a specific range can ensure that the metasurface has a significantly increased transmittance, that is to say, the increasement of the transmittance is achieved.

TABLE 6

| Transmittance of | Embodiments 6-8 | | Comparisons 6-8 | |
|---|---|---|---|---|
| Embodiments 6-8 | (with antireflection film) | | (with antireflection film) | |
| (without antireflection | equivalent | | equivalent | |
| film) | optical path | Transmittance | optical path | Transmittance |
| 84.72% | 0.97253 | 93.93% | 2.70 | 88.34% |
| 84.72% | 2.40 | 95.86% | 2.59 | 84.92% |
| 84.72% | 1.352 | 94.15% | 0.53 | 87.66% |

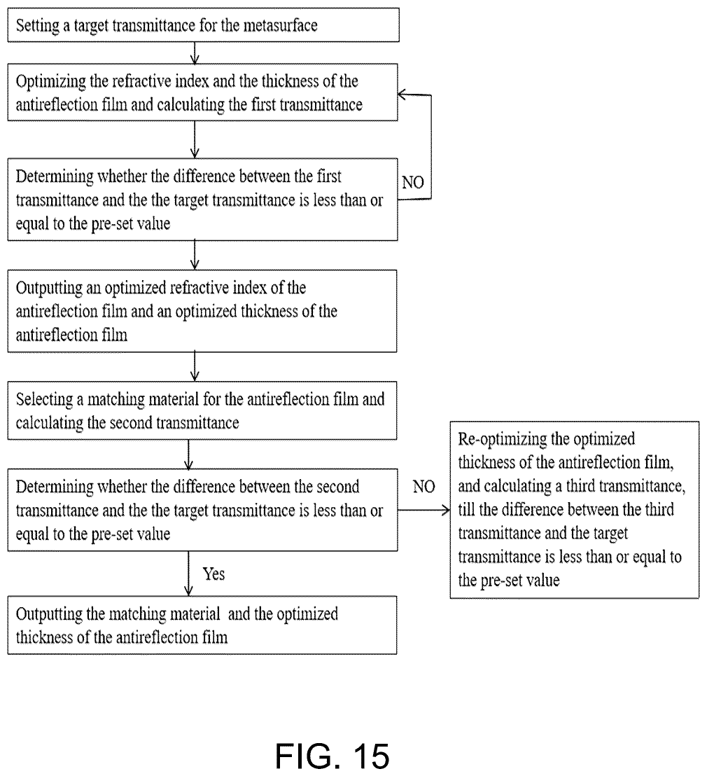

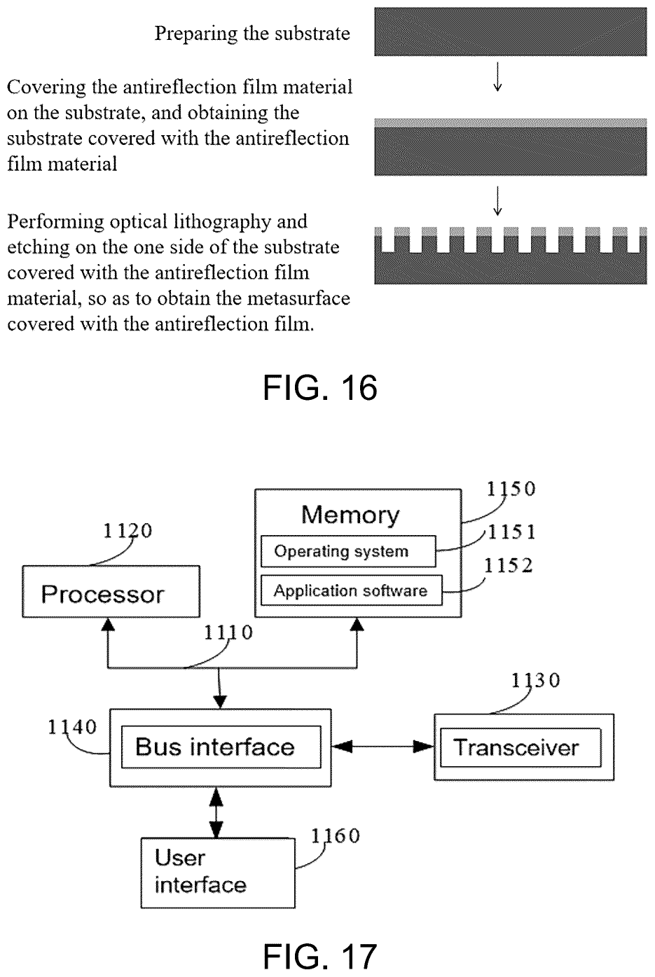

A design method for a metasurface is provided by the present disclosure, the design method for a metasurface can be implemented to the metasurface mentioned above. And the design method for a metasurface as shown in FIG. 15 includes:
setting a target transmittance for the metasurface 1;
inputting and optimizing the refractive index and the thickness of the antireflection film 30, till obtaining a first transmittance of the metasurface 1 that covered with an antireflection film 30 according to the refractive index and the thickness of the metasurface 1, and the difference between the first transmittance and the target transmittance is less than or equal to the pre-set value;
outputting an optimized refractive index of the antireflection film 30 and an optimized thickness of the metasurface 1;
selecting a matching material for the antireflection film 30 in the material database, and the difference between the refractive index of the matching material for the antireflection film 30 and the refractive index of the optimized antireflection film 30 is minimum;
calculating a second transmittance of the metasurface 1 covered with the antireflection film 30 according to the refractive index and the optimized antireflection film 30;
determining whether the difference between the second transmittance and the target transmittance is less than or equal to the pre-set value;
if the difference between the second transmittance and the target transmittance is less than or equal to the pre-set value, then outputting the matching material for the antireflection film 30 and the optimized thickness of the antireflection film 30;
if the difference between the second transmittance and the target transmittance is greater to the pre-set value, re-optimizing the optimized thickness of the antireflection film 30, and calculating a third transmittance of the metasurface 1 for the antireflection film 30 according to the refractive index of the matching material for the antireflection film 30 and the re-optimized thickness of the antireflection film 30, till the difference between the third transmittance and the target transmittance is less than or equal to the pre-set value.

In one embodiment, the pre-set value is less than or equal to 3%. Preferably, the pre-set value is less than or equal to 1%.

In one embodiment, before the step “inputting and optimizing the refractive index and the thickness of the antireflection film”, the design method for a metasurface includes: inputting a parameter of the structure. And the parameter of the structure includes: the working waveband of the metasurface 1, and the periodicity and depth of the negative nanostructure 20. And the parameters of the structure may also include: the range of the radius, filler materials and the type of substrate material.

In one embodiment, the optimized refractive index of the antireflection film and the thickness of the antireflection film includes: the initial refractive index and the initial thickness are randomly generated in the inputting range of the refractive index and the thickness. The transmittance of the metasurface 1 with the antireflection film is calculated by the initial refractive index and the initial thickness, and determining whether the difference between the transmittance and the target transmittance is less than or equal to the pre-set value. If the difference between the transmittance and the target transmittance is less than or equal to the pre-set value, then outputting the optimized refractive index of the antireflection film 30 and the optimized thickness of the antireflection film 30. If the difference between the transmittance and the target transmittance is greater to the pre-set value, the refractive index used for next round calculation and the thickness used for the next round calculation are randomly generated in the inputting range of the refractive index and the thickness by the optimizing arithmetic, till the transmittance is less than or equal to the target transmittance.

In one embodiment, when selecting the matching material for the antireflection film, except for considering the difference between the refractive index of the matching material and the optimized refractive index of the anti-reflective film is the minimum value, the adhesion between the matching material and the metasurface, the difficulty for coating and the cost of the fabrication should also be considered.

In one embodiment, the step of “re-optimizing the optimized thickness of the antireflection film 30” includes: taking the refractive index of the matching material of the antireflection film as the optimal refractive index, and only optimizing the optimized thickness of the antireflection film 30. The applicants found that the problem that the difference between the first transmittance of the metasurface and the second transmittance of the metasurface will not satisfy the pre-set value. And the problem mainly results from the difference between the matching material of the antireflection film and the refractive index of the optimized antireflection film. Therefore, in the subsequent optimization, the matching material of the antireflection film is used as the optimal matching material of the antireflection film. The step of the re-optimizing is the same as the previous step of the optimization. Only the original two optimization parameters are changed to one optimization parameter, that is to say, only the parameter of the thickness of the antireflection film is optimized. After optimizing, the optimal parameters of the thickness corresponding to the matching material of the antireflection film.

A design device for a metasurface 1 is provided by the present disclosure, and the design device for a metasurface is used to implement the design method mentioned above, and the design device includes:
an optimizing module, the optimizing module is used to input and optimize the refractive index and the thickness of the antireflection film;
a matching module, the matching module is used to select a matching material for the antireflection film, and the difference between the refractive index of the material of the matching layers and the optimized refractive index of the antireflection film;
a calculating module, the calculating module is used to calculate the transmittance of the metasurface 1 covered with the antireflection film 30;
a determining module, the determining module is used to determine whether the difference between the transmittance obtained by calculation and the target transmittance is less than or equal to the pre-set value.

In addition, an electronic device is provided by the present disclosure, and the electronic device includes: a bus 1110, a processor 1120, a transceiver 1130, a bus interface 1140, a memory 1150, and a user interface 1160.

In the embodiment of the present disclosure, the electronic device also includes a computer program stored on the memory 1150 and the computer program can be implemented the steps of the design method on the processor 1120. In one embodiment, the transceiver 1130 is used for receiving and transmitting data under the control of the processor 1120. And a bus framework (represented by the bus 1110), the bus 1110 any number of interconnected buses and bridges. The bus 1110 represents one or more of any one of a plurality of types of bus structures. The bus 1110 includes a memory bus and a local bus of any structure in a memory controller, a peripheral bus, an Accelerate Graphical Port (AGP), a processor or an architecture using various buses. For illustration rather than limitation, the architecture includes an Industry Standard Architecture (ISA) bus, a Micro Channel Architecture (MCA) bus, an Enhanced ISA (EISA) bus, a Video Electronics Standards Association (VESA) bus, a Peripheral Component Interconnect (PCI) bus. The bus 1110 is configured to connect various circuits of one or more processors represented by the processor 1120 and a memory represented by the memory 1150. The processor 1120 may be an integrated circuit chip with signal processing capabilities. During the implementation processes, respective steps of the method described in the above embodiments may be completed by instructions in the form of integrated logic circuits in hardware or software in the processor. The processor may be a general-purpose processor, a Central Processing Unit (CPU), a Network Processor (NP), a Digital Signal Processor (DSP), an Application Specific Integrated Circuit (ASIC), a Field Programmable Gate Array (FPGA), a Complex Programmable Logic Device (CPLD), a Programmable Logic Array (PLA), a Microcontroller Unit (MCU) or other equipment such as a programmable logic device, a discrete gate, a transistor logic device, a discrete hardware component, which are capable of implementing or executing the method, respective steps and logical block diagrams disclosed in the present embodiment. For example, the processor may be a single-core processor or a multi-core processor. The processor may be integrated into a single chip or located on multiple different chips.

The processor 1120 may be a microprocessor or any conventional processor. The steps of the method disclosed in the present embodiment may be directly executed by a hardware decoding processor, or may be executed by a combination of a hardware module and a software module in a decoding processor. The software module may be provided in a readable storage media including Random Access Memory (RAM), Flash Memory (Flash Memory), Read-Only Memory (ROM), Programmable Read-Only Memory (PROM), Erasable PROM (EPROM) and a register, which are known in the art. The readable storage medium is located in the memory. The processor reads the information in the memory and completes the steps of the method in combination with the hardware of the processor.

The bus 1110 may also realize the circuit connection of other devices such as peripheral equipment, a voltage regulator or a power management circuit. The bus interface 1140 provides an interface between the bus 1110 and the transceiver 1130, which are known in the art. The general knowledge will not be described herein.

The transceiver 1130 may be an element or may be multiple elements, such as multiple receivers and multiple transmitters. The transceiver 1130 is configured to serve as a unit for communicating with various other devices over a transmission medium. For example, the transceiver 1130 receives external data from other devices, and the transceiver 1130 is used to send the processed data by the processor 1120 to other devices. Depending on the type of the computer system, a user interface 1160 may also be provided. The user interface 1160 may be a touch screen, a physical keyboard, a monitor, a mouse, a speaker, a microphone, a trackball, a joystick or a stylus.

It should be understood that in the present embodiment, the memory 1150 may further include memories remotely located relative to the processor 1120. The memories may be connected to a server through a network. One or more parts of the network may be an ad hoc network, an intranet, an extranet, a virtual private network (VPN), a local area network (LAN), a wireless local area network (WLAN), a wide area network (WAN), a wireless wide area network (WWAN), a metropolitan area network (MAN), Internet, a public switched telephone network (PSTN), a plain old telephone service (POTS) network, a cellular telephone network, a wireless network, a wireless fidelity (Wi-Fi) network or a combination thereof. The combination includes at least two kinds of networks listed herein. For example, the cellular telephone network and the wireless network may be a Global System for Mobile Communications (GSM), Code Division Multiple Access (CDMA), Worldwide Interoperability for Microwave Access (WiMAX), General Packet Radio Service (GPRS), a Broadband CDMA (WCDMA) system, a Long Term Evolution (LTE) system, an LTE Frequency Division Duplex (FDD) system, an LTE Time Division Duplex (TDD) system, a Long Term Evolution Advanced (LTE-A) system, a Universal Mobile Telecommunications (UMTS) system, an Enhanced Mobile Broadband (eMBB) system, a massive Machine Type of Communication (mMTC) system, an Ultra Reliable Low Latency Communications (uRLLC) system, etc.

It should be understood that the memory 1150 in the present embodiment may be a volatile memory, a non-volatile memory, or a combination thereof. Where, the non-volatile memory may be a Read-Only Memory (ROM), a Programmable ROM (PROM), and an Erasable PROM (EPROM), an Electrically EPROM (EEPROM) or a Flash Memory. The Volatile memory may be a Random Access Memory (RAM), which is used as an external cache. The RAM may be of various types. For illustration but not limitation, the RAM may be a Static RAM (SRAM), a Dynamic RAM (DRAM), a Synchronous DRAM (SDRAM), a Double Data Rate SDRAM (DDRSDRAM), an Enhanced SDRAM (ESDRAM), a synchronous link DRAM (SLDRAM) or a Direct Rambus RAM (DRRAM). The memory 1150 described in the present embodiment may be any of memories listed herein or may be any of other appropriate memories, and the present embodiment is not limited thereto.

In the embodiment of the present disclosure, the memory 1150 stores the following elements of an operating system 1151 and an application program 1152, including an executable module and a data structure, a subset of the operating system 1151 and the application program 1152 or an extended set of the operating system 1151 and the application program 1152. Specifically, the operating system 1151 includes a variety of system programs including a framework layer, a core library layer and a driver layer, which are used to implement various basic services and process hardware-based tasks. The application program 1152 includes a variety of application programs including a Media Player and a Browser, which are used to implement various application services. Programs of implementing the method of the embodiments of the present disclosure may be included in the application program 1152. The application program 1152 includes applets, objects, components, logic, data structures, and other computer-executable instructions that perform specific tasks or implement specific abstract data types.

Furthermore, the embodiment of this disclosure also provides a computer-readable storage medium in which a computer program is stored, and the computer program is executed by a processor, so as to implement the method of designing the antireflection film of the metalens, the computer program when executed by the processor can achieve the same technical effect.

The computer-readable storage medium includes a media that is a non-transitory or transitory storage medium and is a removable or a non-removable storage medium. The media is a tangible device being capable of reserving and storing instructions which are usable to an instruction execution device. The computer-readable storage medium may be an electronic storage device, a magnetic storage device, an optical storage device, an electromagnetic storage device, a semiconductor storage device, or a combination thereof. In the several embodiments provided in the present disclosure, it should be understood that the disclosed devices, electronic equipment and methods, can be implemented in other ways. For example, the above-described embodiments of the device are merely schematic, e.g., the division of the described modules or units is merely a logical functional division, and the actual implementation may be divided in other ways, e.g., multiple units or components may be combined or may be integrated into another system, or some features may be ignored, or not implemented. Furthermore, the mutual coupling or direct coupling or communication connection shown or discussed may be indirect coupling or communication connection through some interface, device or unit, or may be connected electrically, mechanically or in some other form.

The units illustrated as separated components may or may not be physically separated, and components shown as units may or may not be physical units, either located at a single location or distributed to a plurality of network units. Some or all of these units may be selected to solve the problem to be solved by the program of embodiments of the present disclosure according to actual needs.

In addition, each functional unit in various embodiments of the present disclosure may be integrated into a single processing unit, or each unit may physically exist separately, or two or more units may be integrated into a single unit. The above-integrated units may be implemented either in the form of hardware or in the form of software functional units.

The integrated unit may be stored in a computer-readable storage medium if implemented as a software functional unit and sold or used as a separate product. Based on this understanding, the technical solution of the embodiments of the present application is essentially or in part a contribution to the prior art, or all or part of the technical solution may be embodied in the form of a software product, which is stored in a storage medium comprising a number of instructions to cause a computer device (including: a personal computer, a server, a data center, or other networked devices) to execute all or part of the steps of the method described in various embodiments of the present application. And the said storage medium includes various media that can store program code as enumerated above.

A fabrication method for a metasurface 1 is provided in the present disclosure, the fabrication method for the metasurface is used to fabricate the metasurface 1. And the fabrication method for metasurface includes:
S1. preparing the substrate 10;
S2. covering a antireflection film material on the substrate 10, and obtaining the substrate 10 covered with the antireflection film material;
S3. performing optical lithography and etching on the one side of the substrate 10 covered with the antireflection film material, so as to obtain the metasurface 1 covered with the antireflection film material.

In one embodiment, the fabrication method for a metasurface 1 also includes:
S4. dicing the substrate 10 covered with the antireflection film 30, obtaining a plurality of metasurfaces 10 covered with the antireflection film.

In one embodiment, the substrate 10 is silicon wafer.

In one embodiment, coating or vapour deposition may be used for covering the antireflection film material on the first side 101 of the substrate 10. Optionally, the vapour deposition may be Chemical Vapor Deposition or Physical Vapor Deposition, etc.

In one embodiment, after obtaining the substrate with the antireflection film material, the photoresist is coated on the surface of the substrate with the antireflection film material. And then the photolithography and etching are implemented on the substrate with the antireflection film material to obtain a metasurface with the antireflection film. Optionally, the etching depth of the substrate with the photoresist and the antireflection film is greater than the sum of the thicknesses of the photoresist and the antireflection film 30.

The negative nanostructure metasurface with the antireflection film provided by the embodiment of the present disclosure is able to improve the transmittance of the electromagnetic wave in the working waveband while realizing the original functions of the metasurface, thus improving the optical efficiency of the optical system. Next, the design method provided by the present disclosure uses iterative optimization to improve the transmittance and the workability of the negative nanostructure metasurface with the antireflection film. The iterative optimization is based on the prior art of the optimization algorithm for the antireflection film to re-optimize the parameters of the optimized refractive index and the thickness. After obtaining the parameters of the optimized refractive index and the optimized thickness, the difference between the optimized refractive index and the antireflection film material will be further considered, and then the parameters of the optimized thickness will be decided to be further optimized. In addition, a fabrication method for a metasurface is provided by the embodiment of the present disclosure. Compared with the fabrication method for the positive nanostructure metasurface with the antireflection film, the fabrication method provided in this disclosure coats the antireflection film material before fabrication, then exposes and etches the whole substrate, which simplifies the fabrication, thus saving the fabrication time and improves the overall production yield.

The above is only a specific embodiment of the embodiment of this disclosure, but the scope of protection of the embodiment of this disclosure is not limited to this, any person familiar with the scope of the change or substitution, should be covered within the protection scope of the embodiment of this disclosure. Therefore, the scope of the protection of the present disclosure shall depend to the scope of the claim.

What is claimed is:

1. A metasurface, wherein an antireflection film is covered on the metasurface;
wherein, the metasurface comprises: a substrate; the substrate comprises: a first side; and the first side of the substrate has a plurality of negative nanostructures at different locations, and the depth of the plurality of negative nanostructures is less than the thickness of the substrate;
the antireflection film is covered on the surface of the first side of the substrate without the plurality of negative nanostructures.

2. The metasurface according to claim 1, wherein the equivalent optical path is greater than or equal to 0.55 um and less than or equal to 3.36 um as the light passes through the antireflection film.

3. The metasurface according to claim 2, wherein the equivalent optical path is greater than or equal to 0.55 um and less than or equal to 2.52 um as the light passes through the antireflection film when the working waveband of the metasurface is a far-infrared band.

4. The metasurface according to claim 3, wherein the equivalent optical path is greater than or equal to 0.8 um and less than or equal to 2.4 um as the light passes through the antireflection film.

5. The metasurface according to claim 2, wherein the equivalent optical path is greater than or equal to 0.99 um and less than or equal to 3.66 um as the light passes through the antireflection film.

6. The metasurface according to claim 5, wherein the equivalent optical path is greater than or equal to 1.44 um and less than or equal to 3.2 um as the light passes through the antireflection film.

7. The metasurface according to claim 5, wherein the effective reflection index of the antireflection film is greater than or equal to 1.1 and less than or equal to 2.1.

8. The metasurface according to claim 1, wherein the antireflection film is a single-layer film.

9. The metasurface according to claim 1, wherein the antireflection film is a multiple-layer film, and the materials of the multiple-layer film are different from each other, or parts of the layers in the multiple-layer film are made of different materials.

10. The metasurface according to claim 1, wherein the material of the antireflection film comprises: any one or more of zinc sulfide, zinc fluoride, magnesium fluoride, silica, and titanium dioxide;
and the material of the substrate comprises silicon.

11. The metasurface according to claim 1, wherein the negative nanostructures are any one or more of cylindrical space, elliptical column space, rectangular column space, square column space, cross column space.

12. The metasurface according to claim 11, wherein the interior of each of the plurality of the negative nanostructures comprises an inner nanostructure, and the inner nanostructure extends from the bottom of the negative nanostructure and aligns with the side surface of the substrate;
the material of the inner nanostructure and the substrate is the same, and the shape of the inner nanostructure is any one or more of columns, elliptical column, rectangular column, square column, cross column.

13. A design method for a metasurface, wherein the design method for a metasurface can be implemented to the metasurface according to claim 1, and the design method for a metasurface comprises:
setting a target transmittance for the metasurface;
inputting and optimizing the refractive index and the thickness of the antireflection film, till obtaining a first transmittance of the metasurface covered with an antireflection film according to the refractive index and the thickness of the metasurface, and the difference between the first transmittance and the target transmittance is less than or equal to the pre-set value;
outputting an optimized refractive index of the antireflection film and an optimized thickness of the metasurface;
selecting a matching material for the antireflection film in the material database, and the difference between the refractive index of the matching material for the antireflection film and the refractive index of the optimized antireflection film is minimum;
calculating a second transmittance of the metasurface covered with the antireflection film according to the refractive index and the optimized antireflection film;
determining whether the difference between the second transmittance and the target transmittance is less than or equal to the pre-set value;
if the difference between the second transmittance and the target transmittance is less than or equal to the pre-set value, then outputting the matching material for the antireflection film and the optimized thickness of the antireflection film;
if the difference between the second transmittance and the target transmittance is greater to the pre-set value, then re-optimizing the optimized thickness of the antireflection film, and calculating a third transmittance of the metasurface for the antireflection film according to the refractive index of the matching material for the antireflection film and the re-optimized thickness of the antireflection film, till the difference between the third transmittance and the target transmittance is less than or equal to the pre-set value.

14. The design method for a metasurface according to claim 13, wherein the pre-set value is less than or equal to 3%.

15. The design method for a metasurface according to claim 13, wherein the pre-set value is less than or equal to 1%.

16. The design method for a metasurface according to claim 13, wherein before the step “inputting and optimizing the refractive index and the thickness of the antireflection film”, the design method for a metasurface comprises:
inputting a parameter of the structure, and the parameter of the structure comprises: the working waveband of the metasurface, and the periodicity and depth of the negative nanostructure.

17. A design device for a metasurface, wherein design device for a metasurface is used to implement design method according to claim 13, and the design device comprises:
an optimizing module, the optimizing module is used to input and optimize the refractive index and the thickness of the antireflection film;
a matching module, the matching module is used to select a matching material for the antireflection film, and the difference between the refractive index of the material of the matching layers and the optimized refractive index of the antireflection film;
a calculating module, the calculating module is used to calculate the transmittance of the metasurface covered with the antireflection film;
a determining module, the determining module is used to determine whether the difference between the transmittance obtained by calculation and the target transmittance is less than or equal to the pre-set value.

18. An electronic device, the electronic device comprises: a bus, a transceiver, a memory, a processor and a computer program;
wherein the computer program is stored in the memory and executable on the processor; the transceiver, the memory and the processor are connected through the bus; the computer program is executed by the processor, so as to implement the method of claim 13.

19. A non-transitory computer-readable storage medium, the non-transitory computer-readable storage medium in which a computer program is stored, wherein the computer program is executed by a processor, so as to implement the method of claim 13.

20. A fabrication method for a metasurface, the fabrication method for the metasurface is used to fabricate the metasurface according to claim 1, wherein the fabrication method for metasurface comprises:
S1. preparing the substrate;
S2. covering the antireflection film material on the substrate, and obtaining the substrate covered with the antireflection film material;
S3. performing optical lithography and etching on the one side of the substrate covered with the antireflection film material, so as to obtain the metasurface covered with the antireflection film.
